(19) United States
(12) Patent Application Publication
(10) Pub. No.: US 2012/0012731 A1
(43) Pub. Date: Jan. 19, 2012

(54) Fastenerless Engine Exhaust Component Suspension Device

(75) Inventor: David J. JOHNSON, Woodbridge (CA)

(73) Assignee: ESW INC., Concord (CA)

(21) Appl. No.: 12/838,015

(22) Filed: Jul. 16, 2010

(51) Int. Cl. F16M 7/00; B23P 11/00; F16M 13/00

(52) U.S. Cl. 248/638; 248/675; 29/428

(57) ABSTRACT

An engine exhaust component suspension system comprising one or more engine exhaust component suspension devices is provided for use in supporting replacement or additional exhaust system components and peripherals+installed in an engine exhaust system. The engine exhaust component suspension device is configured to be capable of being fastenerlessly secured to a vehicle frame, allowing mounting of exhaust system components without the need for modification of the vehicle frame. The engine exhaust component suspension system also allows for mounting of exhaust system components that cannot be mounted on a vehicle's original equipment mounts. A method for installing an engine exhaust component suspension system comprising one or more engine exhaust component suspension devices is also provided.

### BACKGROUND

This application is related to supports for automotive components, and in particular for engine exhaust system components and peripherals.

Modifications to the exhaust systems of internal combustion vehicles often require the addition of new components or the replacement of the vehicle's exhaust system original equipment. One way to modify an exhaust system is to place an additional or replacement component into the exhaust system, such as an additional catalyst, that may further clean and filter the engine exhaust so that the resulting exhaust has less particulate matter and reduced greenhouse gasses. Such a replacement or addition may be done, for example, in order to meet government-mandated emissions standards.

Replacement or add-on exhaust system components may not be mechanically suitable for mounting on original equipment supports. When placement of an additional component is required, the vehicle may not be equipped with sufficient support mechanisms on which to place an additional component. For example, a replacement component may be too heavy for the support mechanisms provided as original equipment on the vehicle. Further, existing support mechanisms or mounting points may not be located in a suitable location for the replacement or add-on exhaust system components. Further complicating placement of replacement or additional components and peripherals is the inability to modify the vehicle frame (e.g., due to government safety regulations) in order to enable support of an additional or replacement exhaust component. Modification of a vehicle exhaust system requiring placement of additional or replacement components may require a new support mechanism.

### SUMMARY

In one embodiment, an engine exhaust component suspension device comprises a first bracket piece and second bracket piece. The first bracket piece has a first strut, a second strut, a second bracket piece receiving portion, and a first bracket support portion. The first strut and second strut are capable of being fastenerlessly secured to the first side of a vehicle frame. The second bracket piece has a frame engaging portion and a first bracket piece engaging portion. The frame engaging portion is capable of being fastenerlessly secured to the second side of the vehicle frame. The first bracket piece engaging portion is configured to be secured to the second bracket piece receiving portion. An exhaust component clamp means secures the engine exhaust component to the device. The exhaust component clamp means is configured to be coupled to the first bracket support portion.

In another embodiment, an engine exhaust component suspension device comprises a support bracket piece and a top bracket piece. The support bracket piece has a first strut (optionally in the shape of a fin), and a second strut (optionally in the shape of a fin), a top bracket piece receiving portion, and a support bracket piece clamp hanging portion. The first and second struts each have a frame engaging edge configured to be fastenerlessly secured to a first side of an unmodified vehicle frame. The top bracket piece has a frame engaging portion and support bracket piece engaging portion. The frame engaging portion is configured to be fastenerlessly secured to the second side of the unmodified vehicle frame. The support bracket piece engaging portion is configured to be secured to the top bracket piece receiving portion.

In another embodiment, a method of installing one or more engine exhaust component suspension devices is provided. An example engine exhaust component suspension device to which this method is applicable comprises a first and second bracket piece. The first bracket piece has a first and second strut, a second bracket piece receiving portion, and a first bracket support portion. The first and second struts are configured to be fastenerlessly secured to the first side of an unmodified vehicle frame. The second bracket piece has a frame engaging portion and first bracket piece engaging portion. The frame engaging portion is configured to be fastenerlessly secured to a second side of the unmodified vehicle frame. The first bracket piece engaging portion is configured to be secured to the second bracket piece receiving portion. The method comprises selecting a location on an unmodified vehicle frame for placement of each engine exhaust component suspension device to be installed. For each of the engine exhaust component suspension devices, the first and second strut of the first bracket piece are placed onto the first side of the unmodified vehicle frame at a selected location. The frame engaging portion of each of the second bracket pieces, one for each corresponding first bracket piece, is placed onto the second side of the unmodified vehicle frame at one of the selected location. The second bracket piece receiving portions are secured to the first bracket piece engaging portions, thereby securing the first bracket pieces and second bracket pieces to the frame at the selected locations.

### BRIEF DESCRIPTION OF THE DRAWINGS

FIG. 1 illustrates an exemplary engine exhaust component suspension system comprising three engine exhaust component suspension devices secured to a portion of a vehicle frame.

FIG. 2 illustrates an exploded view of one of the engine exhaust component suspension devices illustrated in FIG. 1.

FIG. 3 illustrates an exploded view of an alternative embodiment of the engine exhaust component suspension device that includes a peripheral supporting portion.

### DETAILED DESCRIPTION

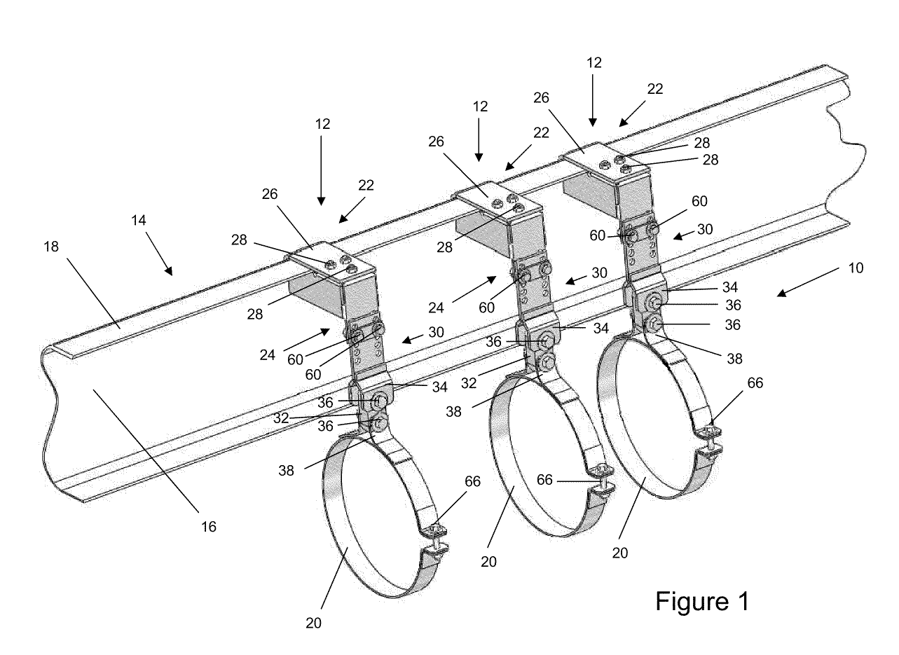

FIG. 1 illustrates an example engine exhaust component suspension system 10. The illustrated system 10 has three engine exhaust component suspension devices 12, although the system 10 need not have three suspension devices 12. For example, the system 10 may have one or more suspension devices 12. In the illustrated embodiment, the three devices 12 are placed along a vehicle frame 14 having a first side 16 and a second side 18 opposite the first side 16. Each of the engine exhaust system suspension devices 12 has an exhaust system clamp 20 that is configured to be capable of being secured to an engine exhaust component (not shown). The system 10 may comprise one or more suspension devices 12 in order to support the weight of the engine exhaust component. When more than one suspension device 12 is used each engine exhaust component suspension device 12 of the engine exhaust component suspension system 10 carries a portion of the weight of the engine exhaust component. The exhaust system clamps 20 shown in FIG. 1 have a generally circular shape and therefore may be secured to an engine exhaust component having a generally circular cross-section. The exhaust system clamps 20 may be removably secured, as with fasteners 66 as shown in FIG. 1, or permanently secured as may be done by various methods including, but not limited to, welding the exhaust system clamps 20 around the exhaust system component (not shown). Further, the clamps 20 need not be in direct contact with the engine exhaust component as an intervening material may be placed between the clamp 20 and the engine exhaust component without interfering with the ability of the clamp 20 to secure the engine exhaust component in place. As used herein, the term secured may mean directly or indirectly secured, permanently, temporarily or removably secured. In an alternative embodiment, the clamps 20 may be configured to have a shape appropriate for securing the clamps 20 to an engine exhaust component having other cross-sectional shapes, such as, without limitation, a rectangular or elliptical cross-sectional shape. The clamps 20 need not precisely track the shape of the engine exhaust component, so long as the engine exhaust component is securely held. The illustrated suspension devices 12 of FIG. 1 are identical, and therefore reference may be made to any one or more of these illustrated suspension devices 12 in the description of FIG. 1 herein. However, when more than one is used, the engine exhaust system suspension devices need not be identical. For example, the multiple clamps may also be configured to be capable of being secured to an engine exhaust component having multiple different cross-sectional shapes along its length.

The engine exhaust component suspension devices 12 shown in FIG. 1 are secured to the vehicle frame 14 by a frame bracket 22. The frame bracket 22 is configured to be capable of being secured to the vehicle frame 14 without the use of fasteners, such as bolts, screws, pins, hook or rivets, coming into contact with the vehicle frame 14, and without the need to alter the vehicle frame 14 in order to accept such a fastener, for example, by drilling a hole into the vehicle frame 14 or welding the frame bracket 22 to the vehicle frame 14. Instead, a first bracket piece 24, also referred to herein as a support bracket piece 24, and second bracket piece 26, also referred to herein as a top bracket piece 26, are secured to one another at a selected location on the vehicle frame 14 by fasteners 28. By securing the frame bracket 22 onto the vehicle frame 14, the first bracket piece 24 becomes secured to the first side 16 of the unmodified vehicle frame 14, and the second bracket piece 26 becomes secured to the second side 18 of the unmodified vehicle frame 14. When the first bracket piece 24 and second bracket piece 26 are fastened to one another and are secured to the first side 16 and the second side 18 of the unmodified vehicle frame 14, respectively, the entire frame bracket 22 is secured to the vehicle frame 14 at the selected location, and is now able to bear at least a portion of the weight of an engine exhaust component mounted to the engine exhaust component suspension system 10. As used herein with reference to the vehicle frame 14, the term “unmodified” or “not modified” should be understood to mean the vehicle frame 14 has not been changed, altered, or otherwise modified in any way, temporarily or permanently, in order to secure the engine exhaust component suspension devices 12 described herein. For example, an unmodified frame would not have the suspension devices 12 described herein welded to the frame 14, and would not have any bores drilled into the frame 14 in order to secure the suspension devices 12 described herein, for example with a bolt or hook. The definition does not encompass changes, alterations, or other modifications made to the frame 14 that are not used to secure the engine exhaust component suspension devices 12 described herein (e.g., repairs made as a result of an accident involving the vehicle, or application of protective coatings, paints or other finishes to the vehicle frame 14). While the illustrated vehicle frame 14 is U-shaped, the suspension devices 12 may be secured to a variety of differently shaped vehicle frames, for example, such as I-shaped or L-shaped frames.

With continued reference to FIG. 1, each of the engine exhaust component suspension devices 12 has a first bracket support portion 30 that is coupled to the exhaust system clamp 20, allowing the clamp 20 to hang from the first bracket support portion 30. As illustrated, the first bracket support portion 30 is indirectly coupled to the exhaust system clamp 20 through a shock-absorbing coupling member 32. The shock-absorbing coupling member 32 serves to absorb movement of the engine exhaust component during operation of the vehicle, thereby limiting strain on the vehicle frame 14 and the engine exhaust component suspension devices 12 and minimizing the risk of failure of the suspension devices 12. The shock-absorbing coupling member 32 may be made of, for example, rubber or plastic. In the illustrated embodiment, the shock-absorbing coupling member 32 is directly coupled to two support tabs 34 of the first bracket support portion 30 by the use of a clamp fastener 36, which may take the form of a standard off-the-shelf nut, bolt, and washer assembled in a manner well known in the art. In the illustrated embodiment, the shock-absorbing coupling member 32 is also directly coupled to two clamp tabs 38 of the exhaust system clamp 20, again by clamp fastener 36. The clamp tabs 38 may be integral with the exhaust system clamp 20, or may be secured to the exhaust system clamp 20, for example by welding. In another configuration (not shown), the first bracket support portion may be indirectly coupled to the exhaust system clamp through a rigid coupling member, such as a metal plate (not shown). In yet another configuration, the first bracket support portion may be directly coupled to the exhaust system clamp, for example through the use of one or more clamp fasteners directly coupling at least one clamp tab to the first bracket support portion. Generally, an exhaust system clamp may be directly or indirectly coupled to a first bracket support portion through a single clamp tab 38 or a plurality of clamp tabs 38. Other structures performing the same function as the illustrated clamp tabs 38 of securing a clamp to a first bracket support portion may be used, such as hooks or other interlocking mechanisms.

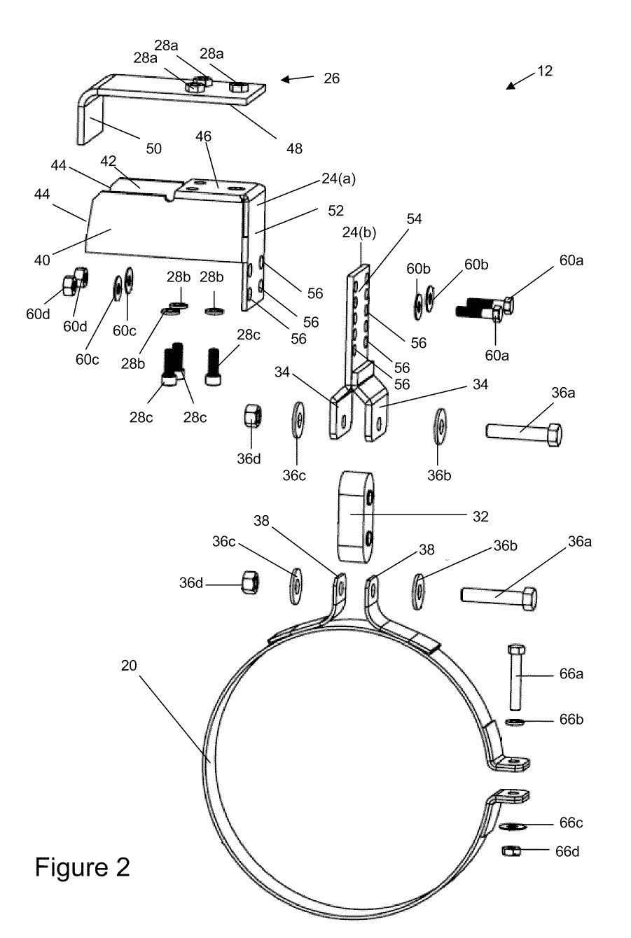

FIG. 2 illustrates an exploded view of an engine exhaust component suspension device 12. As illustrated, in some cases the first bracket piece 24 may be separated into a first component 24(a) and a second component 24(b), where the first component 24(a) has a first strut 40 and a second strut 42, both in the shape of a fin each having a frame engaging edge 44 that engages the vehicle frame 14. The first strut 40 and a second strut 42 are rigid and provide a force normal to the surface of the vehicle frame 14, thereby helping to support the weight of the engine exhaust component. The first component 24(a) also has a second bracket receiving portion 46 that is configured to be capable of being engaged with and fastened to the first bracket engaging portion 48 of the second bracket piece 26. The second bracket piece 26 has a frame engaging portion 50 that engages the second side 18 of the unmodified vehicle frame 14. As used herein, the terms engaging or engage shall mean both directly engaging, such as being in direct contact, and indirectly engaging, for example when an intervening pad or other protective material is place between two items, such as the frame engaging portion 50 and the second side of the unmodified vehicle frame 14, or the first strut 40 and a second strut 42 and the first side of the vehicle frame 16. In the illustrated embodiment, the first component 24(a) and second bracket piece 26 are secured to one another by fasteners 28, which may take the form of nuts 28a, washers 28b, and threaded bolts 28c. However, the first component 24(a) and second bracket piece 26 may also be secured to one another by other means, such as by welding the first component 24(a) and second bracket piece 26 together.

With continued reference to FIG. 2, the first component 24(a) comprises a first adjustment portion 52 and the second component 24(b) comprises a second adjustment portion 54. As illustrated, the first adjustment portion 52 has four fastener bores 56 in two columns of two bores 56 in each evenly spaced row. The second adjustment portion 54 has ten fastener bores 56 in two columns each having five evenly spaced rows. The fastener bores 56 in the first adjustment portion 52 and second adjustment portion 54 are spaced such that the first adjustment portion 52 and second adjustment portion 54 may be selectively secured relative to one another with fasteners 60, which may take the form of threaded bolts 60a, washers 60b and 60c, and nuts 60d, allowing for a plurality of different possible lengths for the first bracket support portion 30 of the first bracket piece 24. Other embodiments may have a different arrangement of bores 56, or other structures that permit selectively securing the first adjustment portion 52 and second adjustment portion 54, such as a series of hooks and apertures in which to insert the hooks, for example (not shown). By selectively securing the first adjustment portion 52 relative to the second adjustment portion 54, the engine exhaust component may be mounted at the desired vertical position relative, for example, to the unmodified vehicle frame 14, or the surface on which the vehicle travels. It should be noted that in one alternative the first adjustment portion 52 and second adjustment portion 54 may be permanently secured, as by welding, at as selected vertical position. The various components of the engine exhaust component suspension device 12 may be made of a variety of materials, for example and not limited to steel and steel based alloys or other alloys, aluminum, cast metal, or non-metallic materials such as graphite-based materials.

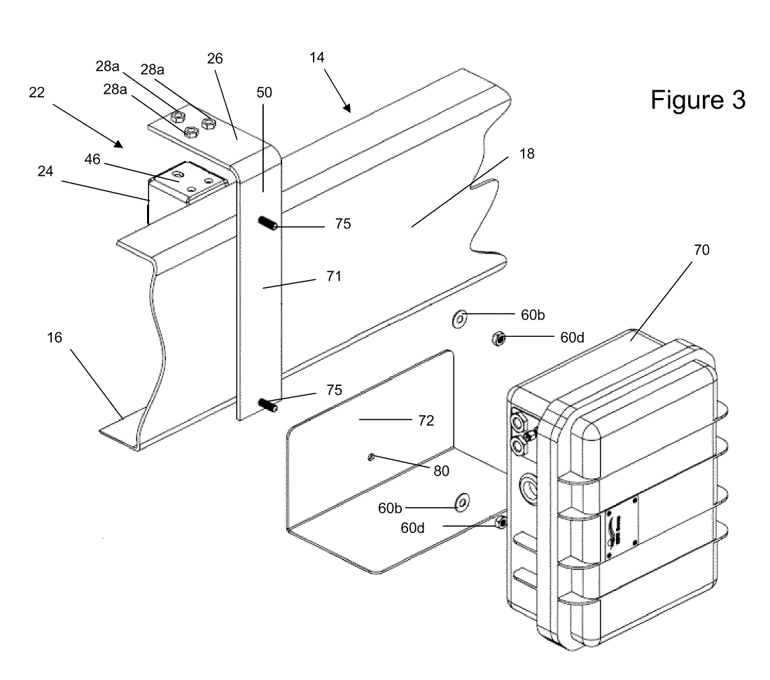

FIG. 3 illustrates an alternative embodiment of the frame bracket 22 that can support a peripheral device 70 without the need to modify the vehicle frame 14. Such peripheral devices 70 may be necessary in order to operate the engine exhaust component. For example, the peripheral device 70 may contain consumable substances used by the engine exhaust component during operation. In the illustrated embodiment, the peripheral device 70 is secured to the frame bracket 22 at a peripheral supporting portion 71 of the top bracket piece 26. As shown in FIG. 3, the frame engaging portion 50 of the top bracket piece 26 comprises a peripheral supporting portion 71. However, other implementations of the peripheral supporting portion 71 need not engage the vehicle frame 14. For example, a peripheral supporting portion may extend from the frame engaging portion 50, for example by hanging from the frame engaging portion 50 of the top bracket piece 26 without engaging the vehicle frame 14.

With continued reference to FIG. 3, the peripheral device 70 may be secured to the peripheral supporting portion 71 by threaded fasteners 75, which may take the form of off-the-shelf threaded bolts passed through the peripheral supporting portion 71, washers 60b and nuts 60d. The threaded fastener 75 may also be integral to the peripheral supporting portion 71. In addition, other structures, such as hook placed on the peripheral supporting portion 71 and a corresponding mating aperture on the peripheral device 70 may be used. A shelf 72 may be implemented to assist in supporting the peripheral device 70. In the illustrated embodiment, the shelf 72 is placed between the peripheral device 70 and the peripheral supporting portion 71. A threaded fastener 75 passes through the shelf 72 at aperture 80 and secures the shelf 72 and peripheral device 70 to the peripheral supporting portion 71 by the use of washers 60b and nuts 60d. Alternatively, the shelf 72 may be omitted, and the peripheral device 70 may be directly or indirectly secured to the peripheral supporting portion 71.

Installing the engine exhaust component suspension device 12 such as shown in FIG. 2 may begin by selecting the location or locations along the unmodified vehicle frame 14 for installing one or more of the engine exhaust component suspension devices 12. Once a location is selected for placement of an engine exhaust system suspension device 12, the support bracket piece 24 and top bracket piece 26 may be placed into position at the selected location. When placed in the selected position, the top bracket receiving portion 46 of the support bracket piece 24 engages the support bracket engaging portion 48 of the top bracket piece 26, allowing the top bracket receiving portion 46 to be secured to the support bracket engaging portion 48. Placement of the support bracket piece 24 and top bracket piece 26 in the selected position also results in the frame engaging edges 44 of the first fin 40 and the second fin 42 engaging the first side 16 of the unmodified vehicle frame 14. Further, the frame engaging portion 50 of the top bracket piece 26 engages the second side 18 of the vehicle frame 14. In general, when assembling the components of the engine exhaust component suspension devices 12, the respective components that are secured to one another may be secured in a removable manner, such as with removable fasteners, or in a permanent or semi-permanent manner, such as with rivets or welding, where desired. Upon securing the top bracket receiving portion 46 to the support bracket engaging portion 48 and upon the vehicle frame 14 as described, the frame bracket 22 is considered to be fastenerlessly secured to the vehicle frame 14.

In one aspect of a method of assembling the engine exhaust component suspension system 10, the first adjustment portion 52 and second adjustment portion 54 are selectively secured to one another, for example by selecting particular fastener bores on the first adjustment portion 52 and second adjustment portion 54 through which to place fasteners 60, which as illustrated in FIG. 2 made up of threaded bolts 60a, washers 60b and 60c, and nuts 60d, thereby securing the first adjustment portion 52 at a particular location with respect to the second adjustment portion 54, which in turn dictates the vertical position of the engine exhaust component relative, for example, to the unmodified vehicle frame 14, or the surface on which the vehicle travels. In another aspect of a method of assembling the engine exhaust component suspension system 10, the exhaust system clamp 20 is directly coupled to a shock-absorbing coupling member 32 through at least one clamp tab 38 and using fastener 36, and is also secured to the engine exhaust component. In the illustrated embodiment, the exhaust system clamp 20 is secured to the engine exhaust component by fastener 66, which may be made up of a threaded bolt 66a, washers 66b and 66c, and nut 66d. The shock-absorbing coupling member 32 is also secured to the first bracket support portion 30, in particular to at least one support tab 34 of the support portion 30 by fastener 36, which in the illustrated embodiment is made up of a threaded bolts 36a, washers 36b and 36c, and nuts 36d. As previously mentioned, in lieu of shock-absorbing coupling member 32, a rigid coupling member may similarly be secured to the first bracket support portion 30 and the exhaust system clamp 20. In yet another alternative method, the exhaust system clamp 20 may be directly coupled to the first bracket support portion 30.

Securing additional engine exhaust component suspension devices 12 at additional selected locations may be performed, for example, according to the method described herein for securing a single engine exhaust component suspension device 12. For example, installing the engine exhaust component suspension system 10 illustrated in FIG. 1 would entail selecting three locations along the unmodified vehicle frame 14 and assembling an engine exhaust component suspension device 12 at each of the three locations.

Although the foregoing apparatuses and methods have been described in some detail, certain changes and modifications may be practiced within the scope of the appended claims. Accordingly, the present embodiments are to be considered as illustrative and not restrictive, and may be modified within the scope and equivalents of the appended claims. For example, the engine exhaust component suspension system 10 need not be limited to supporting engine exhaust system components, and may be applied to other instrumentalities that may be secured to a vehicle frame, such as storage components or engine components.

1. An engine exhaust component suspension device for use with a vehicle comprising a frame, the engine exhaust component suspension device comprising:
a first bracket piece and second bracket piece;
the first bracket piece comprising a first strut portion and second strut portion, a second bracket piece receiving portion, and a first bracket support portion, the first strut and second strut capable of being fastenerlessly secured to a first side of a vehicle frame;
the second bracket piece having a frame engaging portion and first bracket piece engaging portion, the frame engaging portion configured to be capable of being fastenerlessly secured to a second side of the vehicle frame, the first bracket piece engaging portion configured to be capable of being in secured to the second bracket piece receiving portion;
a means for securing the engine exhaust component to the engine exhaust component suspension device, the means configured to be capable of being coupled to the first bracket support portion.

2. The engine exhaust component suspension device of claim 1, wherein the first bracket support portion comprises a first and second adjustment portion, the first adjustment portion and second adjustment portion having a plurality of vertically spaced fastener bores configured to be capable of receiving fasteners to secure the first adjustment portion at a selected vertical position relative to the second adjustment portion.

3. The engine exhaust component suspension device of claim 1 wherein the means for securing the engine exhaust component to the engine exhaust component suspension device is configured to be capable of being directly coupled to the first bracket support portion of the first bracket piece.

4. The engine exhaust component suspension device of claim 1 wherein the means for securing the engine exhaust component to the engine exhaust component suspension device is configured to be capable of being indirectly coupled to the first bracket support portion through a rigid coupling member, the means for securing the engine exhaust component to the engine exhaust component suspension device and the first bracket support portion configured to be capable of being directly coupled to the rigid coupling member.

5. The engine exhaust component suspension device of claim 1 wherein the means for securing the engine exhaust component to the engine exhaust component suspension device is configured to be capable of being indirectly coupled to the first bracket support portion through a shock-absorbing coupling member, the means for securing the engine exhaust component to the engine exhaust component suspension device and the first bracket support portion configured to be capable of being directly coupled to the shock-absorbing coupling member.

6. The engine exhaust component suspension device of claim 5 wherein the means for securing the engine exhaust component to the engine exhaust component suspension device comprises at least one clamp tab, the first bracket support portion comprises at least one support tab, wherein the at least one clamp tab and the at least one support tab are configured to be capable of being directly coupled to the shock-absorbing coupling member.

7. The engine exhaust component suspension device of claim 1 wherein the second bracket piece comprises a peripheral support portion configured to be capable of supporting a peripheral device.

8. An engine exhaust component suspension device comprising:
a support bracket piece and top bracket piece;
the support bracket piece having a first fin and second fin, a top bracket piece receiving portion, and a support bracket piece clamp hanging portion, the first fin and second fin each having a frame engaging edge configured to be capable of being fastenerlessly secured to a first side of a vehicle frame without the need for modifying the vehicle frame;
the top bracket piece having a frame engaging portion and support bracket piece engaging portion, the frame engaging portion configured to be capable of being fastenerlessly secured to a second side of the vehicle frame without the need for modifying the vehicle frame, the support bracket piece engaging portion configured to be capable of being secured to the top bracket piece receiving portion.

9. The engine exhaust component suspension device of claim 8, wherein the support bracket piece comprises first and second adjustment portions each having a plurality of vertically spaced fastener bores configured to permit selective securement of the first adjustment portion at a selected vertical position relative to the second adjustment portion.

10. The engine exhaust component suspension device of claim 8, further comprising a means for securing the engine exhaust component to the support bracket piece clamp hanging portion.

11. The engine exhaust component suspension device of claim 8 further comprising an exhaust component clamp having at least one tab configured to be capable of being coupled to the support bracket piece clamp hanging portion, the exhaust component clamp configured to be capable of being secured to the engine exhaust component, the exhaust component clamp configured to be capable of at least partially supporting the engine exhaust component.

12. A method of installing an engine exhaust component suspension device that comprises a first bracket piece and second bracket piece, with the first bracket piece having a first strut and second strut, a second bracket piece receiving portion, and a first bracket support portion, the first strut and second strut configured to be capable of being fastenerlessly secured to a first side of an unmodified vehicle frame, with the second bracket piece having a frame engaging portion and first bracket piece engaging portion, the frame engaging portion configured to be capable of being fastenerlessly secured to a second side of the unmodified vehicle frame, the first bracket piece engaging portion configured to be capable of being in secured to the second bracket piece receiving portion, the method comprising:
selecting a location on a vehicle frame for placement of the engine exhaust component suspension device;
placing the first strut and second strut of the first bracket piece in fastenerless engagement with a first side of the vehicle frame at the selected location;
placing a frame engaging portion of the second bracket piece in fastenerless engagement with a second side of the vehicle frame at the selected location;
securing the second bracket piece receiving portion to the first bracket piece engaging portion such that the device is secured to the vehicle frame at the selected location without modifying the vehicle frame.

13. The method of installing an engine exhaust component suspension device of claim 12, further comprising securing an exhaust component clamp to the first bracket support portion of the first bracket piece and the engine exhaust component.

14. The method of installing an engine exhaust component suspension device of claim 13, further comprising securing the exhaust component clamp to the engine exhaust component.

15. The method of installing an engine exhaust component suspension device of claim 12, further comprising selecting at least one additional location on the vehicle frame for placement of at least one additional engine exhaust component suspension device;
placing the first strut and second strut of at least one additional first bracket piece in fastenerless engagement with the first side of the unmodified vehicle frame at one of the at least one additional selected locations;
placing the frame engaging portion of at least one additional second bracket piece in fastenerless engagement with the second side of the unmodified vehicle frame at the one of the at least one additional selected locations;
securing the second bracket piece receiving portion of the at least one additional first bracket piece to the first bracket piece receiving portion of the at least one additional second bracket piece to secure the at least one additional first bracket piece and the at least one additional second bracket piece at the one of the at least one additional selected locations.

16. The method of installing an engine exhaust component suspension device of claim 15 wherein two additional locations on the unmodified vehicle frame are chosen for placement of two additional engine exhaust component suspension devices, and securing an additional engine exhaust component suspension device at each of the two additional locations.

17. The method of installing an engine exhaust component suspension device of claim 12, the first bracket support portion having a first and second adjustment portion, at least one of the first and second adjustment portions having a plurality of vertically spaced fastener bores configured to capable of permitting the first adjustment portion to be secured at a selected vertical position relative to the second adjustment portion, the method comprising selectively securing the first adjustment portion at a height relative to the second adjustment portion.
